(19) United States
(12) Patent Application Publication
(10) Pub. No.: US 2026/0077609 A1
(43) Pub. Date: Mar. 19, 2026

(54) LIQUID EJECTION APPARATUS

(71) Applicant: SEIKO EPSON CORPORATION, Tokyo (JP)

(72) Inventor: Shin KOMATSU, MATSUMOTO-SHI (JP)

(21) Appl. No.: 19/324,518

(22) Filed: Sep. 10, 2025

(30) Foreign Application Priority Data
Sep. 13, 2024 (JP) 2024-158961

(51) Int. Cl. B41J 29/17; B41J 11/00

(52) U.S. Cl. CPC B41J 29/17; B41J 11/007

(57) ABSTRACT

A liquid ejection apparatus includes a conveyance belt that conveys a fabric and has an outer peripheral surface on which the fabric can be placed, an ejection unit that ejects a liquid to the fabric placed on the outer peripheral surface and conveyed, a cleaning unit that cleans the outer peripheral surface, a cleaning liquid tank that stores a cleaning liquid in which a part of the cleaning unit is immersed, a supply unit that supplies the cleaning liquid to the cleaning liquid tank and includes an opening and closing unit that switches between an open state in which the cleaning liquid is supplied to the cleaning liquid tank and a closed state in which the cleaning liquid is not supplied to the cleaning liquid tank, and a control unit that controls the opening and closing unit to adjust a supply amount of the cleaning liquid supplied from the supply unit to the cleaning liquid tank.

The present application is based on, and claims priority from JP Application Serial Number 2024-158961, filed September 13, 2024, the disclosure of which is hereby incorporated by reference herein in its entirety.

### BACKGROUND

### 1. Technical Field

The present disclosure relates to a liquid ejection apparatus.

### 2. Related Art

In the related art, a liquid ejection apparatus that performs printing by ejecting a liquid onto a medium such as paper or fabric has been known. Such a liquid ejection apparatus includes an apparatus for conveying a medium with a conveyance belt. For example, JP-A-2014-136625 discloses a recording apparatus including an endless belt for conveying a recording medium as a medium and a belt cleaning device for cleaning the endless belt.

JP-A-2014-136625 is an example of the related art.

However, the apparatus described in JP-A-2014-136625 has a problem that it is difficult to adjust a supply amount of a cleaning liquid supplied to a cleaning liquid storage unit. Specifically, the cleaning liquid is supplied from a cleaning liquid supply unit to the cleaning liquid storage unit. In the apparatus, adjustment of the supply amount of the cleaning liquid is not clearly shown. When a user adjusts the supply amount by opening and closing a manual valve or the like, the supply amount is likely to be excessive or insufficient. In addition, it is difficult to set and reproduce a suitable supply amount according to an operation status of the apparatus. That is, there is a demand for a liquid ejection apparatus that can easily adjust the supply amount of the cleaning liquid.

### SUMMARY

A liquid ejection apparatus includes: a conveyance belt configured to convey a medium and having an outer peripheral surface configured to allow the medium to be placed thereon; an ejection unit configured to eject a liquid to the medium placed on the outer peripheral surface and conveyed; a cleaning unit configured to clean the outer peripheral surface; a cleaning liquid tank configured to store a cleaning liquid in which a part of the cleaning unit is immersed; a supply unit configured to supply the cleaning liquid to the cleaning liquid tank and including an opening and closing unit that switches between an open state in which the cleaning liquid is supplied to the cleaning liquid tank and a closed state in which the cleaning liquid is not supplied to the cleaning liquid tank; and a control unit configured to control the opening and closing unit to adjust a supply amount of the cleaning liquid supplied from the supply unit to the cleaning liquid tank.

### BRIEF DESCRIPTION OF THE DRAWINGS

FIG. 1 is a schematic diagram showing a configuration of a liquid ejection apparatus according to a first embodiment.

FIG. 2 is a schematic diagram showing a configuration of a belt cleaning mechanism.

FIG. 3 is a schematic diagram showing a display example of an operation panel.

FIG. 4 is a schematic diagram showing a display example of the operation panel.

FIG. 5 is a schematic diagram showing a display example of the operation panel.

FIG. 6 is a schematic diagram showing a display example of the operation panel.

FIG. 7 is a schematic diagram showing a display example of the operation panel.

FIG. 8 is a schematic diagram showing a display example of the operation panel.

FIG. 9 is a schematic diagram showing a display example of the operation panel.

FIG. 10 is a graph showing a relationship between a hourly average water supply amount and time.

FIG. 11 is a schematic diagram showing a display example of an operation panel according to a second embodiment.

FIG. 12 is a schematic diagram showing a display example of the operation panel.

FIG. 13 is a schematic diagram showing a display example of the operation panel.

FIG. 14 is a graph showing a relationship between a hourly average water supply amount and time according to a reference example.

### DESCRIPTION OF EMBODIMENTS

In the embodiments described below, a liquid ejection apparatus used for digital textile printing of fabric will be described with reference to the drawings. The application of the liquid ejection apparatus of the present disclosure is not limited to textile printing.

In each of the following drawings, X, Y, and Z axes, which are coordinate axes perpendicular to one another, are given as necessary, a direction indicated by an arrow is defined as a positive (+) direction, and a direction opposite to the positive direction is defined as a negative (-) direction. When the liquid ejection apparatus is placed on a horizontal surface such as a floor, a Z direction is a vertical direction. A +Z direction may be referred to as an upward direction, and a -Z direction may be referred to as a downward direction. For convenience of illustration, a size of each member is different from an actual size.

In a conveyance path of fabric wound in a roll shape after fabric as a medium is unwound from raw fabric and is textile-printed, the raw fabric side is sometimes referred to as an upstream, and the side on which the fabric is wound is sometimes referred to as a downstream. In addition, a direction in which the fabric is conveyed from the upstream to the downstream is a conveyance direction.

### 1. First Embodiment

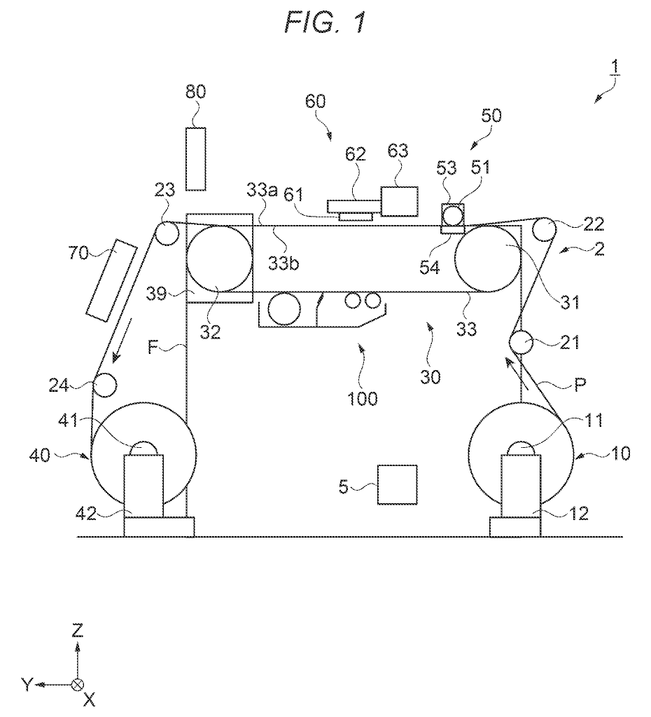

As shown in FIG. 1, a liquid ejection apparatus 1 according to the present embodiment includes a control unit 5, a medium transporting unit 2, a recording mechanism 60, a drying unit 70, a winding unit 40, an operation panel 80, and a belt cleaning mechanism 100. The liquid ejection apparatus 1 also includes a housing (not shown). Each configuration of the liquid ejection apparatus 1 is supported by a frame F.

The liquid ejection apparatus 1 produces a printed material by causing a liquid such as ink to adhere to fabric P as a medium and forming an image such as a picture, a photograph, a text, or a pattern on the fabric P. In the description related to FIG. 1, unless otherwise specified, a state viewed from an -X direction will be described.

The control unit 5 is electrically coupled to each component of the liquid ejection apparatus 1 and integrally controls an operation of each component. Although details will be described below, the control unit 5 particularly controls the supply of the cleaning liquid in the belt cleaning mechanism 100.

The control unit 5 includes hardware such as a central processing unit (CPU), a read only memory (ROM), and a random access memory (RAM). The control unit 5 executes a predetermined control program by the CPU. The ROM is a nonvolatile storage device and stores a control program executed by the CPU and data processed by the control program. The RAM constitutes a work area of the CPU. The CPU loads the control program read from the ROM or the like into the RAM and executes the loaded control program.

The operation panel 80 is also electrically coupled to the control unit 5. The operation panel 80 displays various types of information to a user of the liquid ejection apparatus 1 and receives an input of various operations and various settings performed by the above-described user. The control unit 5 controls the liquid ejection apparatus 1 according to the information input to the operation panel 80. In the following description, the user of the liquid ejection apparatus 1 is also simply referred to as a user.

The operation panel 80 is supported by the frame F via a member (not shown), and is disposed above the liquid ejection apparatus 1 and at an end portion in a +Y direction. The user stands in the +Y direction of the liquid ejection apparatus 1 and performs various inputs while viewing the operation panel 80. The operation panel 80 is, for example, a liquid crystal display of a touch panel type. The operation panel 80 may include physical buttons in addition to the liquid crystal display.

The medium transporting unit 2 includes a medium supply unit 10, transport rollers 21, 22, 23, 24, a conveyance mechanism 30, and the winding unit 40. The medium transporting unit 2 transports the fabric P along a conveyance path from the upstream to the downstream.

The medium supply unit 10 includes a supply shaft 11, a bearing 12, and a rotational drive unit (not shown). The supply shaft 11 has a substantially cylindrical shape and holds a core of the raw fabric of the fabric P. The bearing 12 detachably and rotatably supports both ends of the supply shaft 11 in a direction along the X axis.

The rotation drive unit is, for example, an electric motor, and rotationally drives the supply shaft 11. With the rotation of the supply shaft 11 and a belt rotating roller 32 of the conveyance mechanism 30 to be described below, the fabric P is unwound from the raw fabric and fed downstream.

The fabric P is transported from the medium supply unit 10 and passes through the transport roller 21, and a transport direction is changed to substantially the +Y direction by the transport roller 22. The fabric P is delivered to the conveyance mechanism 30 from substantially the -Y direction.

Examples of the fiber that is a material of the fabric P include natural fibers such as cotton, silk, hemp, mohair, wool, and cashmere, regenerated fibers such as rayon and cupra, and synthetic fibers such as nylon, polyester, and polyurethane, which are in the form of a single yarn, a double yarn, or a blended yarn. The fabric P is formed by processing the above-described fibers into a woven fabric or a nonwoven fabric. In order to improve various characteristics of a product produced from the textile-printed fabric P, the fabric P may be processed in advance.

The conveyance mechanism 30 includes belt rotating rollers 31, 32, a conveyance belt 33, and a pressure bonding unit 50.

The conveyance belt 33 is located between the transport roller 22 and the transport roller 23 and conveys the fabric P. The conveyance belt 33 is an endless belt and is stretched by the belt rotating rollers 31, 32 in a region including a position facing the recording mechanism 60 in an up-down direction. The conveyance belt 33 has an outer peripheral surface 33a and an inner peripheral surface 33b. The outer peripheral surface 33a and the inner peripheral surface 33b are in a front-back relationship. The fabric P may be placed on the outer peripheral surface 33a. An adhesive layer (not shown) is provided on the outer peripheral surface 33a.

The conveyance belt 33 conveys the fabric P in the conveyance direction by bringing the fabric P into close contact with the adhesive layer of the outer peripheral surface 33a. The conveyance belt 33 is rotationally driven counterclockwise by the belt rotating rollers 31, 32. The conveyance direction of the fabric P in the conveyance belt 33 is the +Y direction.

The width of the conveyance belt 33 is larger than the width of the fabric P in the direction along the X axis. A direction intersecting the conveyance direction is defined as a conveyance belt width direction. In the embodiment, the width direction of the conveyance belt 33 is a direction along the X axis.

The belt rotating rollers 31, 32 are substantially cylindrical rotation members and are paired with each other. Each of the belt rotating rollers 31, 32 is rotatable about a rotation axis along the X axis. The belt rotating roller 31 and the belt rotating roller 32 are disposed to face each other in the direction along the Y axis. The belt rotating roller 31 is disposed upstream of the conveyance mechanism 30 and near the transport roller 22 in the +Y direction. The belt rotating roller 32 is disposed downstream of the conveyance mechanism 30 and near the transport roller 23 in the -Y direction. A support member that supports the conveyance belt 33 may be disposed between the belt rotating roller 31 and the belt rotating roller 32.

The belt rotating roller 31 is a driven roller to which the rotation of the belt rotating roller 32 is transmitted via the conveyance belt 33 and which rotates counterclockwise. The belt rotating roller 31 is rotatably supported by a roller support unit (not shown).

The belt rotating roller 32 is rotationally driven counterclockwise by a conveyance drive motor (not shown). The conveyance drive motor is controlled by the control unit 5. The belt rotating roller 32 is rotatably supported by a roller support unit 39.

The fabric P is delivered from the transport roller 22 to the conveyance mechanism 30 and placed on the outer peripheral surface 33a of the conveyance belt 33 above the belt rotating roller 31. At this time, the fabric P may not be in close contact with the outer peripheral surface 33a.

The outer peripheral surface 33a supports the fabric P from below. The inner peripheral surface 33b is in contact with the belt rotating roller 31 and the belt rotating roller 32. The conveyance belt 33 is rotationally driven by a friction force between the inner peripheral surface 33b and the belt rotating roller 32. The belt rotating roller 31 is driven by the friction force between the inner peripheral surface 33b and the belt rotating roller 31.

In the direction along the X axis, which is the width direction of the conveyance belt 33, the width of the adhesive layer of the outer peripheral surface 33a is substantially equal to the width of the conveyance belt 33. A path of the conveyance belt 33 from the belt rotating roller 31 to the belt rotating roller 32 is a conveyance path of the fabric P. A path in which the conveyance belt 33 is folded back by the belt rotating roller 32 toward the belt rotating roller 31 is defined as a non-conveyance path. The outer peripheral surface 33a faces upward in the conveyance path and faces downward in the non-conveyance path.

The adhesive layer of the outer peripheral surface 33a comes into close contact with the fabric P by an adhesive force. The adhesive layer includes, for example, an adhesive material such as a silicone resin, an acrylic resin, or a urethane resin. In the conveyance path, the fabric P is in close contact with the outer peripheral surface 33a of the conveyance belt 33 and is conveyed in the +Y direction together with the circulation of the conveyance belt 33.

The pressure bonding unit 50 is disposed near the belt rotating roller 31 in the +Y direction. The pressure bonding unit 50 includes a pressing roller 51, a pair of support units 53, a heating unit 54, and a pair of drive units (not shown). The pressure bonding unit 50 brings the fabric P into close contact with the adhesive layer of the conveyance belt 33.

The pressing roller 51 is a substantially cylindrical rotation member. The pressing roller 51 has a rotation axis along the X axis and is disposed above the conveyance belt 33. The support units 53 are disposed at both ends of the pressing roller 51 in the direction along the X axis. The pressing roller 51 is rotatably supported by the pair of support units 53. Each of the pair of support units 53 is supported by the drive unit. In the direction along the X axis, the length of the pressing roller 51 is substantially equal to the width of the conveyance belt 33.

One of the drive units is further disposed at a position in the -X direction with respect to the support unit 53 that supports an end portion of the pressing roller 51 in the -X direction. The other one of the drive units is further disposed at a position in the +X direction with respect to the support unit 53 that supports an end portion of the pressing roller 51 in the +X direction.

The pair of drive units move in the up-down direction while supporting the pair of support units 53 by an elevation drive motor (not shown). Therefore, the pressing roller 51 can be displaced in the up-down direction while being supported by the support unit 53. Accordingly, the strength of the pressing force with which the pressing roller 51 presses the fabric P against the adhesive layer of the outer peripheral surface 33a is adjusted.

Although not shown, the pair of drive units also reciprocate in the direction along the Y axis while supporting the pair of support units 53 by driving the guide member and the motor. Therefore, the pressing roller 51 is supported by the support unit 53 and can reciprocate in the direction along the Y axis.

The heating unit 54 heats the conveyance belt 33. The heating unit 54 is disposed below the pressing roller 51 via the conveyance belt 33. An upper surface of the heating unit 54 is formed in a substantially planar shape and is in contact with the lower inner peripheral surface 33b of the conveyance belt 33 in the conveyance path. The distance of the heating unit 54 in the direction along the Y axis is substantially equal to the distance by which the pressing roller 51 reciprocates in the conveyance direction and the reverse conveyance direction. The distance of the heating unit 54 in the direction along the X axis is substantially equal to the width of the conveyance belt 33 in the direction along the X axis.

The heating unit 54 is, for example, an electric heater. The adhesive layer on the outer peripheral surface 33a of the conveyance belt 33 is heated by the heating of the heating unit 54. The flexibility of the adhesive layer is increased by heating, and the adhesive force to the fabric P is increased. The heating temperature by the heating unit 54 is, for example, 35°C or higher and 60°C or lower on the upper surface of the heating unit 54.

In the pressure bonding unit 50, the fabric P is placed on the upper surface of the heating unit 54 via the conveyance belt 33. The heating unit 54 heats the conveyance belt 33, and the pressing roller 51 presses the fabric P against the adhesive layer from above. In parallel with this, the pressing roller 51 reciprocates in the +Y direction and the -Y direction while rotating. The fabric P and the conveyance belt 33 are sandwiched and pressed between the upper surface of the heating unit 54 and the pressing roller 51, and the fabric P and the outer peripheral surface 33a come into close contact with each other. The fabric P is conveyed in the +Y direction via the pressure bonding unit 50 while being in close contact with the conveyance belt 33. Instead of the heating unit 54, the pressing roller 51 may have a function of heating the conveyance belt 33. In addition, the heating unit 54 may be omitted.

The recording mechanism 60 faces the outer peripheral surface 33a and the fabric P in the up-down direction in the middle of the conveyance belt 33 in the direction along the Y axis. The recording mechanism 60 performs textile printing on the fabric P supported by the conveyance belt 33. The recording mechanism 60 includes an ejection unit 61, which is an inkjet head, a carriage 62, and a guide rail 63.

The guide rail 63 is a structural member extending along the X axis, and is disposed above the conveyance mechanism 30. The guide rail 63 supports the carriage 62 such that the carriage 62 is movable in the direction along the X axis. The carriage 62 is supported by the guide rail 63 and reciprocates in the direction along the X axis by driving of a carriage drive motor (not shown). The ejection unit 61 is attached below the carriage 62 and reciprocates in the direction along the X axis with respect to the conveyance belt 33 together with the carriage 62.

The ejection unit 61 ejects a liquid such as ink and a functional liquid and causes the liquid to adhere to the fabric P placed on the outer peripheral surface 33a and conveyed. The ejection unit 61 has a nozzle surface (not shown) at a position facing downward. The nozzle surface faces the conveyance belt 33 and the fabric P in the up-down direction. A plurality of nozzle rows are disposed on the nozzle surface. Each of the plurality of nozzle rows includes a plurality of nozzles. Each of the plurality of nozzle rows individually ejects a plurality of types of inks exhibiting colors such as cyan, magenta, yellow, and black, and a functional liquid onto the fabric P. Examples of the ink include an aqueous ink and a non-aqueous ink. In the embodiment, the aqueous ink is applied.

In the ejection unit 61, a piezoelectric element is used as an actuator which is a drive unit. The drive unit is not limited thereto. As the drive unit, for example, electromechanical conversion elements that displace vibrating plates as the actuators with electrostatic adsorption, or electrothermal conversion elements that eject the ink as droplets using air bubbles generated by heating may be applied.

Although not shown, the ink and the functional liquid are each supplied from an ink tank to the ejection unit 61 via a pipe. The ink and the functional liquid ejected from the ejection unit 61 adhere to the surface of the fabric P facing upward.

The fabric P is conveyed in the +Y direction by the conveyance belt 33 while reciprocating the ejection unit 61 in the direction along the X axis. At this time, a liquid such as ink adheres to the fabric P from the ejection unit 61 at a predetermined timing. Accordingly, a desired image or the like is formed on the fabric P.

The functional liquid is specifically a softener or a pretreatment liquid. The ejection of the functional liquid to the fabric P is performed at the same timing as or before or after the ejection of the ink.

When the textile-printed fabric P is processed into a fabric product such as clothes, the softener has a function of improving the texture of the fabric product. The softener is not particularly limited, and a known softener or the like can be applied. When the softener contains a cationic component or the like, the cationic component may react with a component of the ink to form an aggregate. Therefore, it is preferable to avoid contact and mixing between the softener and the ink.

The pretreatment liquid has a function of aggregating a coloring material such as a pigment in the ink on the surface of the fabric P to improve the color development of the printed material. Such a pretreatment liquid is not particularly limited, and a known treatment agent or the like can be applied. The pretreatment liquid aggregates the coloring material, and therefore, it is preferable to avoid contact and mixing between the pretreatment liquid and the ink for a purpose other than the original purpose.

As the functional liquid, a functional liquid other than the softener and the pretreatment liquid may be applied. Examples of other functional liquids include a coating liquid that improves abrasion resistance and washing fastness of the textile-printed fabric P, and a penetrant liquid that assists permeation of ink into the fabric P.

In the ejection unit 61, preliminary ejection is performed at a stage before ejection of the ink and the functional liquid onto the fabric P, between ejections, and the like. The preliminary ejection is performed for reasons such as prevention of drying and fixation of the ink and the functional liquid at a gas-liquid interface in each nozzle of the ejection unit 61 and prevention of color mixture after cleaning of each nozzle. The execution of the preliminary ejection is controlled by the control unit 5. The timing of preliminary ejection, the time interval, the amounts of ink and functional liquid to be preliminarily ejected, and the like are appropriately set according to the types and characteristics of the ink and the functional liquid.

The fabric P subjected to textile printing is further conveyed in the +Y direction from a position facing the recording mechanism 60. Then, the fabric P is peeled off from the conveyance belt 33 substantially above the belt rotating roller 32, and is delivered to the transport roller 23 downstream of the belt rotating roller 32.

The conveyance belt 33 is folded back from the conveyance path to the non-conveyance path by the belt rotating roller 32, and moves in the -Y direction in a state where the outer peripheral surface 33a faces downward.

The belt cleaning mechanism 100 cleans the outer peripheral surface 33a of the conveyance belt 33. The belt cleaning mechanism 100 is disposed on a lower side of the conveyance belt 33, which corresponds to the non-conveyance path, and faces the outer peripheral surface 33a in the up-down direction.

A liquid such as ink and dirt such as lint from the fabric P and foreign matter are likely to adhere to the outer peripheral surface 33a because the adhesive layer is provided, the fabric P is conveyed in close contact, the preliminary ejection is performed, and the like. When the dirt on the outer peripheral surface 33a is significant, the fabric P may be contaminated when the conveyance belt 33 circulates and comes into contact with the fabric P before textile printing again. In addition, the adhesive force of the adhesive layer may decrease due to dirt on the outer peripheral surface 33a. In response to this, the liquid ejection apparatus 1 cleans the dirt on the outer peripheral surface 33a of the conveyance belt 33 by the belt cleaning mechanism 100. The details of the belt cleaning mechanism 100 will be described below.

The transport roller 23 peels off the fabric P subjected to textile printing from the conveyance belt 33. The fabric P peeled off from the conveyance belt 33 is transported substantially in the +Y direction, and the conveyance direction is changed substantially downward by the transport roller 23. The transport rollers 23, 24 relay the fabric P to the winding unit 40.

The drying unit 70 is disposed between the transport roller 23 and the transport roller 24. The drying unit 70 dries the ink and the functional liquid adhering to the fabric P. The drying unit 70 includes, for example, an infrared heater. Volatile components contained in the ink and the functional liquid adhering to the fabric P are volatilized by the infrared rays radiated by the infrared heater. Accordingly, the droplets of the ink and the functional liquid are dried, and the fabric P can be wound around the winding unit 40. The fabric P proceeds to the winding unit 40 via the transport roller 24.

The winding unit 40 is disposed downstream of and below the transport roller 24. The winding unit 40 collects the textile-printed material that is the printed fabric P. The winding unit 40 includes a winding shaft 41, a bearing 42, and a rotation drive unit (not shown). The winding shaft 41 has a substantially cylindrical shape and winds the printed material in a roll shape. The bearing 42 rotatably supports both ends of the winding shaft 41 in the direction along the X axis. The winding shaft 41 can be attached to and detached from the bearing 42. The rotation drive unit rotates the winding shaft 41 counterclockwise. The winding shaft 41 is rotated by the rotation drive unit, and the printed material is wound. As described above, the printed material is produced by the liquid ejection apparatus 1.

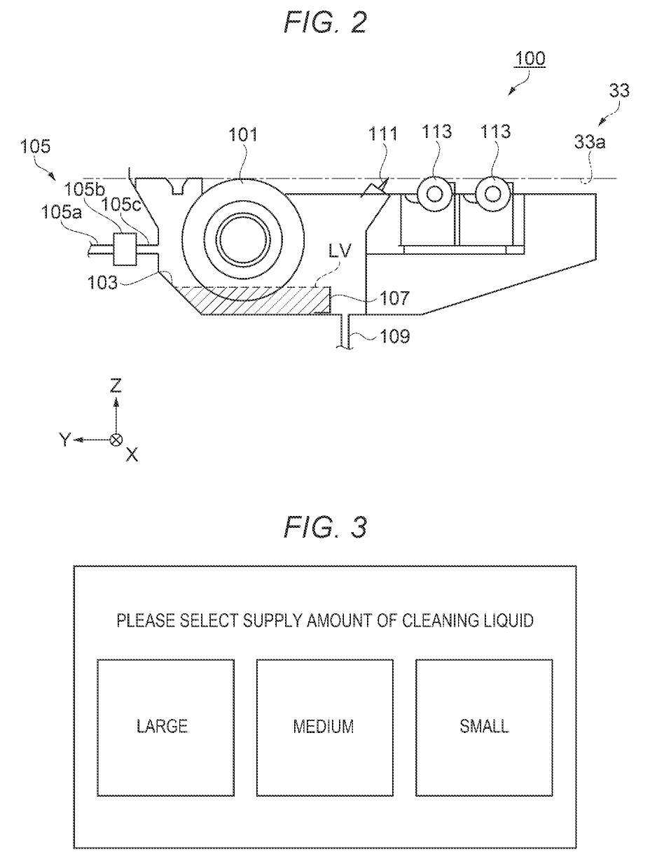

As shown in FIG. 2, the belt cleaning mechanism 100 includes a cleaning unit 101, a cleaning liquid tank 103, a supply unit 105, a defining unit 107, a discharge unit 109, a scraping unit 111, and wiping units 113. As described above, the belt cleaning mechanism 100 cleans and removes the dirt adhering to the outer peripheral surface 33a of the conveyance belt 33. In FIG. 2, the conveyance belt 33 in the non-conveyance path is indicated by a one-dot chain line. In the non-conveyance path, the conveyance belt 33 moves in the -Y direction.

The cleaning unit 101, the scraping unit 111, and the wiping unit 113 are located at positions in contact with the outer peripheral surface 33a of the conveyance belt 33 and are disposed in the above-described order in the -Y direction. Therefore, the outer peripheral surface 33a of the conveyance belt 33 slides against the cleaning unit 101, the scraping unit 111, and the wiping unit 113 in this order.

The cleaning liquid tank 103 has a bathtub shape with an open top, and stores a cleaning liquid for cleaning the outer peripheral surface 33a. The cleaning liquid tank 103 is disposed below the cleaning unit 101. The cleaning liquid is stored at the bottom of the cleaning liquid tank 103. A part of the cleaning unit 101 is immersed in the cleaning liquid stored in the cleaning liquid tank 103. In the direction along the X axis, the width of the cleaning liquid tank 103 is larger than the width of the cleaning unit 101.

The cleaning liquid is selected according to the type of ink or functional liquid applied to the liquid ejection apparatus 1. As the cleaning liquid, for example, water or a water-soluble solvent such as alcohol is used. The cleaning liquid may contain additives such as a surfactant and an antifoaming agent. The cleaning liquid is supplied to the liquid ejection apparatus 1 from a supply source (not shown) such as a water supply or a cleaning liquid tank. In the present embodiment, tap water is used as the cleaning liquid.

The supply unit 105 supplies the cleaning liquid to the cleaning liquid tank 103. The supply unit 105 includes a pipe 105a, an opening and closing unit 105b, and a supply pipe 105c, and is provided in the +Y direction of the cleaning liquid tank 103. The cleaning liquid is introduced from the pipe 105a to the supply unit 105, and is supplied from the supply pipe 105c to the cleaning liquid tank 103 via the opening and closing unit 105b.

The pipe 105a connects the supply source of the cleaning liquid and the opening and closing unit 105b. The pipe 105a is coupled to a tap water faucet via, for example, a flexible hose. An inside of the pipe 105a and an inside of the opening and closing unit 105b communicate with each other. The cleaning liquid is introduced from the pipe 105a to the opening and closing unit 105b.

The opening and closing unit 105b changes the supply amount of the cleaning liquid supplied to the cleaning liquid tank 103. The opening and closing unit 105b is switched between an open state in which the cleaning liquid is supplied to the cleaning liquid tank 103 and a closed state in which the cleaning liquid is not supplied. The above-described control unit 5 controls the opening and closing unit 105b to adjust the supply amount of the cleaning liquid supplied from the supply unit 105 to the cleaning liquid tank 103.

The flow path (not shown) of the opening and closing unit 105b is fully opened in the open state and is fully closed in the closed state. The degree of opening of the flow path in the opening and closing unit 105b is defined as the opening degree. The opening degree in the open state is 100%, and the opening degree in the closed state is 0%. The opening degree may be freely adjusted within a range of more than 0% and less than 100% in addition to 0% and 100%. A known valve mechanism such as a solenoid valve is applied to the opening and closing unit 105b.

The supply pipe 105c connects the opening and closing unit 105b and the cleaning liquid tank 103. The supply pipe 105c is coupled to a side wall of the cleaning liquid tank 103 in the +Y direction, and communicates with the flow path in the opening and closing unit 105b and the inside of the cleaning liquid tank 103. The cleaning liquid supplied from the supply pipe 105c is accumulated at the bottom of the cleaning liquid tank 103 along the above-described side wall of the cleaning liquid tank 103. The arrangement of the supply unit 105 is not limited to the above description.

The defining unit 107 defines a liquid level Lv of the stored cleaning liquid in the cleaning liquid tank 103. The defining unit 107 is disposed in the -Y direction of the bottom of the cleaning liquid tank 103. The defining unit 107 is a plate-shaped partition member. The defining unit 107 protrudes upward from the bottom of the cleaning liquid tank 103 along an XZ plane. The cleaning liquid is stored in a region defined by the side wall and the bottom of the cleaning liquid tank 103 and the defining unit 107. In FIG. 2, the above-described region is hatched with oblique lines. When the cleaning liquid is further supplied from the state shown in FIG. 2, the cleaning liquid flows over the defining unit 107 and overflows in the -Y direction. The overflowed cleaning liquid is discharged from the discharge unit 109 to the outside of the cleaning liquid tank 103.

The liquid level Lv of the cleaning liquid stored in the cleaning liquid tank 103, that is, the upper limit of the liquid surface is defined by the defining unit 107, and therefore, the cleaning liquid is prevented from being stored in the cleaning liquid tank 103 more than necessary. Further, it is possible to overflow the cleaning liquid and to maintain the cleanliness of the stored cleaning liquid by supplying the cleaning liquid to the cleaning liquid tank 103.

The cleaning unit 101 cleans the outer peripheral surface 33a of the conveyance belt 33. The cleaning unit 101 is a substantially cylindrical brush having a central axis along the X axis. Although not shown, the cleaning unit 101 is supported by a support member and is rotated counterclockwise about the central axis by a drive motor.

The cleaning unit 101 comes into contact with the outer peripheral surface 33a while rotating, and dirt such as ink is cleaned. The dried product of the ink that cannot be removed by the cleaning unit 101 comes into contact with the cleaning liquid transferred from the cleaning unit 101, and is easily removed with the cleaning liquid. Then, the above-described dried product is removed by the scraping unit 111 at the subsequent stage of the cleaning unit 101. After sliding against the outer peripheral surface 33a, the cleaning unit 101 rotates to be immersed in the cleaning liquid, and the dirt scraped off from the outer peripheral surface 33a is transferred to the cleaning liquid and is cleaned.

Here, when the supply amount of the cleaning liquid to the cleaning liquid tank 103 is too small, the concentration of the ink and the content of the foreign matter in the stored cleaning liquid increase. Then, the cleanliness of the cleaning unit 101 decreases, and the cleaning capability of removing dirt on the outer peripheral surface 33a may not be ensured. Further, when the supply amount of the cleaning liquid is excessive, the amount of the cleaning liquid discharged from the discharge unit 109 increases, and the cleaning liquid may be wasted. In response to this, the liquid ejection apparatus 1 prevents the occurrence of excess or insufficiency of the cleaning liquid by adjusting the supply amount.

The scraping unit 111 scrapes off the adhering cleaning liquid, dried product, and the like from the outer peripheral surface 33a in contact with the cleaning unit 101. The scraping unit 111 is a substantially plate-shaped rubber member. The cleaning liquid and the dried product scraped off from the outer peripheral surface 33a fall downward and are discharged from the discharge unit 109.

The wiping unit 113 sucks and removes the cleaning liquid and the like remaining on the outer peripheral surface 33a. The wiping unit 113 is a substantially cylindrical sponge member having a central axis along the X axis. In the direction along the X axis, the width of the wiping unit 113 is smaller than the width of the outer peripheral surface 33a. When viewed from above, the wiping units 113 are alternately disposed. The wiping units 113 are rotated counterclockwise by an electric motor (not shown). When the outer peripheral surface 33a passes through the wiping units 113, the entire region of the outer peripheral surface 33a in the direction along the X axis slides against either one of the wiping units 113.

As described above, the outer peripheral surface 33a of the conveyance belt 33 is cleaned. The cleaning of the conveyance belt 33 by the belt cleaning mechanism 100 is performed at least during a period in which the printed material is produced by the liquid ejection apparatus 1. The above-described cleaning may be performed before or after the production of the printed material in addition to the period described above.

Next, the adjustment of the supply amount of the cleaning liquid by the control unit 5 will be described. The following description also refers to FIGS. 1 and 2.

The control unit 5 adjusts the supply amount of the cleaning liquid supplied from the supply unit 105 to the cleaning liquid tank 103 by controlling a time ratio between the open state and the closed state in the opening and closing unit 105b. Specifically, the time ratio is a ratio of a time for which the opening degree is 0% to a time for which the opening degree is 100% in a certain period. When the opening and closing unit 105b is controlled only in the open state and the closed state, adjustment similar to freely changing the opening degree in a range from 0% to 100% in a certain period can be performed by changing the time ratio.

Specifically, for example, in a certain period, when an opening degree in a half period is set to 100% and an opening degree in the other half period is set to 0%, the total supply amount in the certain period is equal to the supply amount when the opening degree is 50%. Accordingly, the supply amount can be freely adjusted only in the open state and the closed state of the opening and closing unit 105b. Adjustment of the supply amount is relatively easy as compared with a case where the opening degree of the opening and closing unit 105b is freely changed in a range of 0% or more and 100% or less.

The control unit 5 controls the time ratio based on information input to the operation panel 80. Specifically, the above-described information is a degree of supply amount, a time ratio, and an average supply amount of the cleaning liquid per unit time. When the user inputs these pieces of information to the operation panel 80, the control unit 5 changes the time ratio according to the information. Accordingly, the user can freely determine the supply amount. In the following description, the average supply amount of the cleaning liquid per unit time is also referred to as an hourly average water supply amount.

One or more setting values indicating the supply amount of the cleaning liquid are displayed on the operation panel 80. Here, the setting value may express the degree of the supply amount in addition to the numerical value of the supply amount. Specifically, for example, as shown in FIG. 3, the supply amount may be expressed as a rough quantity such as large, medium, and small. Although not particularly limited, the open state is set for the entire period when the supply amount is large in a certain period. When the supply amount is medium, the period of 2/3 is in the open state, and the remaining period of 1/3 is in the closed state. When the supply amount is small, the period of 1/2 is in the open state, and the remaining period of 1/2 is in the closed state.

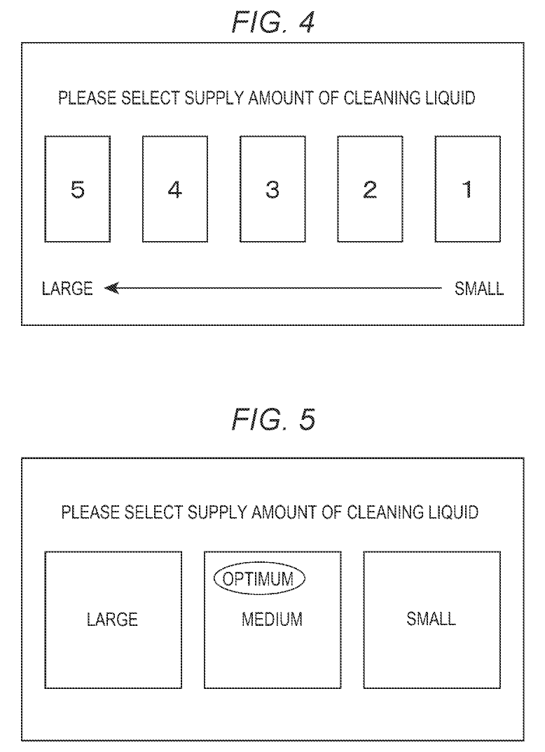

Further, as shown in FIG. 4, the supply amount may be displayed as an index value of four or more stages according to a certain degree.

The control unit 5 controls and changes the time ratio based on a setting value selected from a plurality of setting values by the user. Accordingly, the convenience for the user is improved because the user himself/herself may select the setting value.

The control unit 5 calculates an optimum value of the supply amount of the cleaning liquid based on one or more of a type of the fabric P which is a medium, a type of liquid such as ink ejected by the ejection unit 61, and image data formed on the fabric P. Here, the term "image data" refers to, for example, an ejection amount of the liquid ejected from the ejection unit 61, such as a printing duty or a printing density.

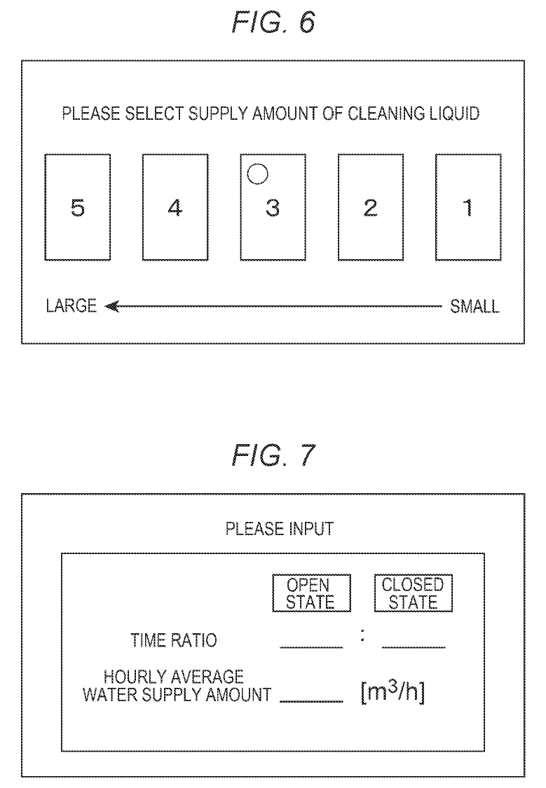

The control unit 5 displays one or more setting values on the operation panel 80 based on the calculated optimum value. Specifically, as shown in FIGS. 5 and 6, a recommended setting value among a plurality of setting values may be marked. Note that the setting value may be displayed without marking. The type of liquid and the image data affect the easiness of dirt on the outer peripheral surface 33a of the conveyance belt 33. Therefore, a suitable setting value corresponding to the degree of dirt is displayed, and thus, the cleanability of the outer peripheral surface 33a of the conveyance belt 33 and the convenience for the user are improved.

One or more values of the time ratio and the average supply amount of the cleaning liquid per unit time may be directly input to the operation panel 80. The control unit 5 controls the time ratio based on the above-described value input to the operation panel 80. Accordingly, the convenience for the user is improved because the user can input any value.

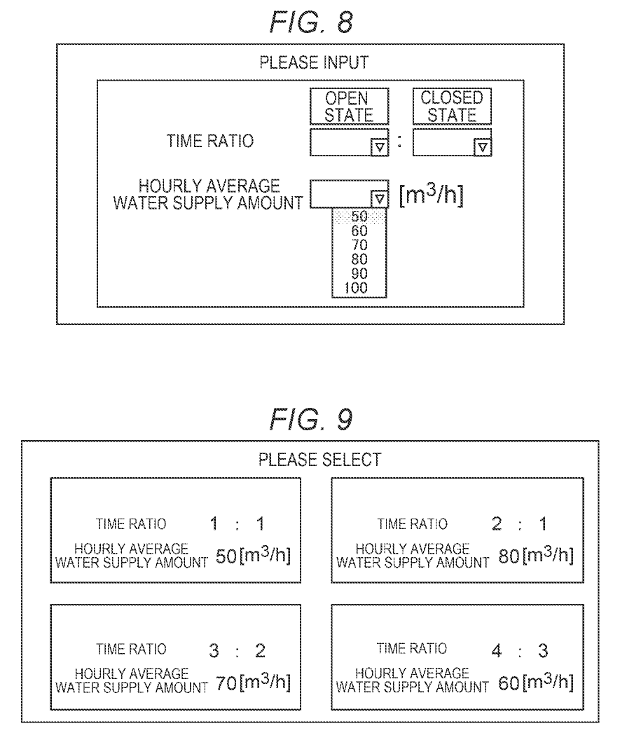

Specifically, for example, as shown in FIG. 7, the user inputs the ratio between the open state and the closed state, which is the time ratio, and the numerical value of the hourly average water supply amount to the operation panel 80. As shown in FIG. 8, the time ratio and the hourly average water supply amount may be selectable from a pull-down menu. Further, as shown in FIG. 9, a plurality of options in which the time ratio and the hourly average water supply amount are displayed together may be displayed, and the user may select one from the plurality of options.

When the time ratio is selected and the value is input or selected, the control unit 5 controls the opening and closing of the opening and closing unit 105b based on the above-described value. At this time, the control unit 5 may calculate an hourly average water supply amount corresponding to the above-described value of the time ratio and display the hourly average water supply amount on the operation panel 80.

When the hourly average water supply amount is selected and the value is input or selected, the control unit 5 calculates the time ratio for achieving the above-described value and controls the opening and closing of the opening and closing unit 105b based on the calculated time ratio. At this time, the control unit 5 may display the calculated time ratio on the operation panel 80.

The control unit 5 may store a table representing a correspondence relationship between the time ratio and the hourly average water supply amount, and may call each value from the table and apply the value without calculating each value. In addition, instead of inputting or selecting the value of the time ratio, a method of inputting or selecting the time for the open state and the time for the closed state may be used.

A cycle for controlling the open state and the closed state can be directly input to the operation panel 80. Here, the term "cycle" refers to a certain period for calculating the time ratio, in other words, a period corresponding to a denominator of the average supply amount per unit time. Accordingly, since the control of the opening and closing unit 105b is periodically repeated according to the content of the image formed on the fabric P, the cleanability of the outer peripheral surface 33a of the conveyance belt 33 and the convenience for the user are improved. When the period during which the belt cleaning mechanism 100 cleans the conveyance belt 33 is longer than the cycle, the control unit 5 may repeatedly perform the control within one cycle.

The cycle described above includes a first cycle and a second cycle, and one or more values of the time ratio and the average supply amount per unit time may be directly input to the operation panel 80 for each of the first cycle and the second cycle. Specifically, in the period during which the printed material is produced, the opening and closing unit 105b is controlled by dividing the cycle according to the content of the image data. For example, when the print density is high in the period corresponding to the first cycle and the print density is low in the period corresponding to the second cycle, the supply amount of the cleaning liquid is increased in the first cycle, and the supply amount of the cleaning liquid is decreased in the second cycle. Accordingly, the supply amount is set in detail, and therefore, a more suitable supply amount of the cleaning liquid can be set.

The control unit 5 may calculate an optimum value of the supply amount of the cleaning liquid based on one or more of the type of the fabric P, the type of the liquid such as ink ejected by the ejection unit 61, and the image data formed on the fabric P, and control the time ratio based on the calculated optimum value. That is, the time ratio is automatically controlled by the control unit 5. Accordingly, the convenience for the user is improved.

The control unit 5 may control the cycle for controlling the open state and the closed state based on one or more of the type of the fabric P, the type of liquid such as ink ejected by the ejection unit 61, and the image data formed on the fabric P. Accordingly, since the time ratio or the like is automatically and periodically changed according to the print condition, the cleanability of the outer peripheral surface 33a of the conveyance belt 33 and the convenience for the user are further improved.

The above-described cycle may include the first cycle and the second cycle, and the control unit 5 may individually control the time ratio for each of the first cycle and the second cycle. Accordingly, the detailed setting is automatically performed, and therefore, the cleanability of the outer peripheral surface 33a of the conveyance belt 33 and the convenience for the user are further improved.

The control unit 5 may determine, based on one or more of the type of the fabric P, the type of the liquid such as the ink ejected by the ejection unit 61, and the image data formed on the fabric P, a cycle for controlling the open state and the closed state, and may execute second control of setting the opening and closing unit 105b to the closed state after executing first control of setting the opening and closing unit 105b to the open state within the period of the above-described cycle based on a predetermined time ratio.

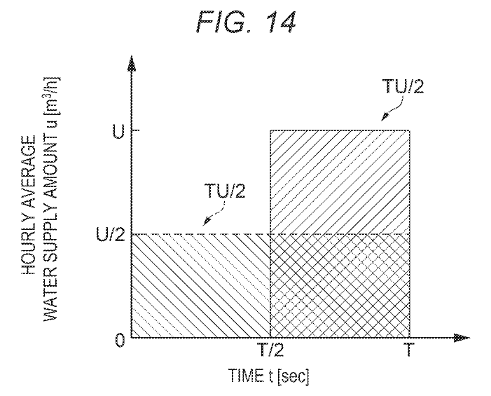

Specifically, as shown in FIG. 14, during time T, the hourly average water supply amount is 0, that is, the opening and closing unit 105b is in a closed state from a time point 0 to a time point T/2, and the hourly average water supply amount is U, that is, the opening and closing unit 105b is in an open state from the time point T/2 to the time point T. In this case, the supply amount from the time point 0 to the time point T/2 is 0, the supply amount from the time point T/2 to the time point T is TU/2, and the supply amount from the time point 0 to the time point T is TU/2. In this case, when the period during which the printed material is produced, that is, the period during which the cleaning is performed is shorter than T, the supply amount is less than TU/2, and the supply amount of the cleaning liquid may be insufficient.

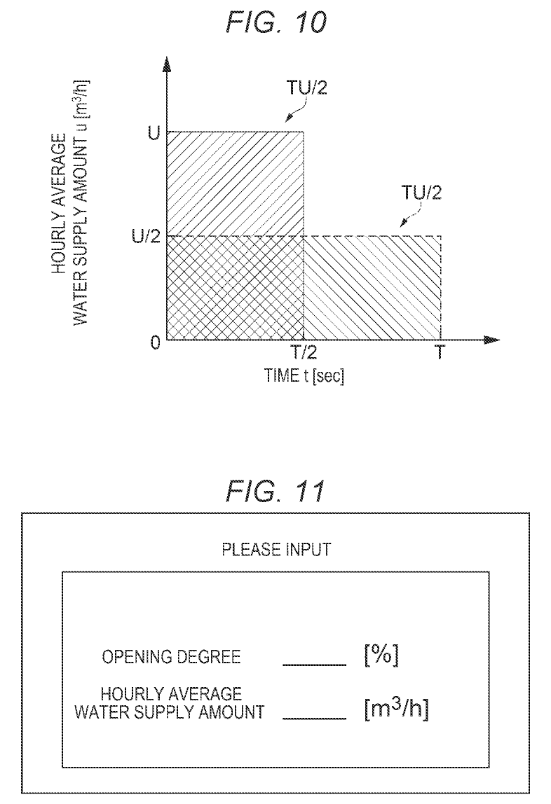

In response to this, as shown in FIG. 10, the opening and closing unit 105b is in the open state as the first control from the time point 0 to the time point T/2, and the opening and closing unit 105b is in the closed state as the second control from the time point T/2 to the time point T. Accordingly, the supply amount of TU/2 is ensured by the first control, and therefore, the supply amount is not insufficient, and the cleanability of the outer peripheral surface 33a of the conveyance belt 33 can be ensured even if the period during which the conveyance belt 33 is cleaned is shorter than the time T. In addition, it is possible to ensure the same supply amount as the case where the opening degree of the opening and closing unit 105b is 50%.

According to the embodiment, the following effects can be obtained.

The supply amount of the cleaning liquid can be easily adjusted. Specifically, the control unit 5 controls the opening and closing unit 105b, and therefore, excess or insufficiency of the cleaning liquid is less likely to occur, and the supply amount can be adjusted without the user spending labor. In addition, it is also possible to easily set and reproduce the supply amount desired by the user according to the operation status of the liquid ejection apparatus 1.

### 2. Second Embodiment

In the embodiment, a method of adjusting the supply amount of the cleaning liquid by the control unit 5 and the opening and closing unit 105b is different from the above-described embodiment. In the embodiment, the same components as those in the first embodiment are denoted by the same reference signs, and redundant description will be omitted.

In the embodiment, the control unit 5 adjusts the supply amount of the cleaning liquid supplied from the supply unit 105 to the cleaning liquid tank 103 by controlling the opening degree of the opening and closing unit 105b. That is, in the embodiment, the opening and closing unit 105b is not controlled only by the opening degree of 0% and the opening degree of 100% in the open state, and the opening degree is freely changed in a range of the opening degree of 0% or more and the opening degree of 100% or less. This point is different from the above-described embodiment.

Accordingly, the supply amount is adjusted according to the opening degree of the opening and closing unit 105b, and therefore, it is possible to quickly adjust the supply amount as compared with the case where the time ratio between the open state and the closed state is changed. In addition to freely changing the opening degree of the opening and closing unit 105b in the range of 0% to 100%, the control of the time ratio may be used in combination.

The control unit 5 controls the opening degree of the opening and closing unit 105b based on the information input to the operation panel 80. The above-described information refers to the opening degree of the opening and closing unit 105b and the hourly average water supply amount as the average supply amount per unit time.

One or more setting values indicating the supply amount of the cleaning liquid are displayed on the operation panel 80. The control unit 5 controls and changes the opening degree based on a setting value selected from one or more setting values by the user. Here, the term "setting value" refers to the opening degree and an average supply amount per unit time. Accordingly, the setting value is displayed, and therefore, the convenience for the user is improved as compared with the case where the user determines the numerical value of the supply amount.

The control unit 5 calculates an optimum value of the supply amount of the cleaning liquid based on one or more of the type of the fabric P, the type of the liquid such as ink ejected by the ejection unit 61, and the image data formed on the fabric P. Then, the control unit 5 displays one or more setting values on the operation panel 80 based on the calculated optimum value. The type of liquid and the image data affect the easiness of dirt on the outer peripheral surface 33a of the conveyance belt 33. Therefore, a suitable setting value corresponding to the degree of dirt is displayed, and thus, the cleanability of the outer peripheral surface 33a of the conveyance belt 33 and the convenience for the user are improved.

A value of the opening degree of the opening and closing unit 105b and a value of the average supply amount per unit time may be directly input to the operation panel 80. The control unit 5 controls the opening degree based on the above-described values input to the operation panel 80. Accordingly, the convenience for the user is improved because the user can input any value.

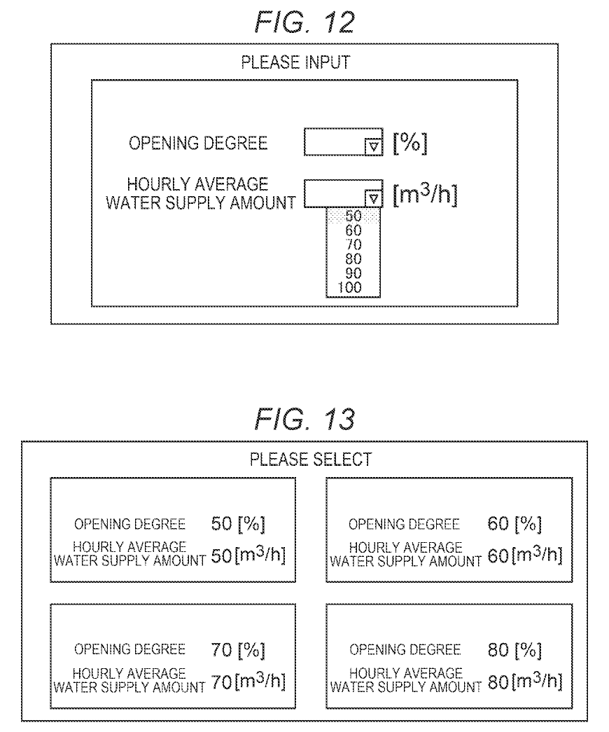

Specifically, as shown in FIG. 11, the user inputs the opening degree or the hourly average water supply amount to the display of the operation panel 80. When the user inputs these pieces of information to the operation panel 80, the control unit 5 changes the opening degree according to the information. As shown in FIG. 12, the opening degree and the hourly average water supply amount may be selectable from a pull-down menu. Further, as shown in FIG. 13, a plurality of options in which the opening degree and the hourly average water supply amount are displayed together may be displayed, and the user may select one from the plurality of options.

A cycle for controlling the open state and the closed state can be directly input to the operation panel 80. Here, the term "cycle" refers to a certain period when the opening degree is adjusted. Accordingly, since the control of the opening degree is periodically repeated according to the content of the image formed on the fabric P, the cleanability of the outer peripheral surface 33a of the conveyance belt 33 and the convenience for the user are improved.

The above-described cycle includes the first cycle and the second cycle. One or more values of the opening degree and the average supply amount per unit time may be directly input to the operation panel 80 for each of the first cycle and the second cycle. Accordingly, the opening degree is set in detail, and therefore, a more suitable supply amount of the cleaning liquid can be set.

The control unit 5 may calculate an optimum value of the supply amount of the cleaning liquid based on one or more of the type of the fabric P, the type of the liquid such as ink ejected by the ejection unit 61, and the image data formed on the fabric P, and control the opening degree of the opening and closing unit 105b based on the calculated optimum value. That is, the opening degree is automatically controlled by the control unit 5. Accordingly, the convenience for the user is improved.

The control unit 5 may control, based on one or more of the type of the fabric P, the type of liquid such as ink ejected by the ejection unit 61, and the image data formed on the fabric P, the cycle for controlling the opening degree. Accordingly, since the opening degree is automatically and periodically changed according to the print condition, the cleanability of the outer peripheral surface 33a of the conveyance belt 33 and the convenience for the user are further improved.

The above-described cycle may include the first cycle and the second cycle, and the control unit 5 may individually control the opening degree of the opening and closing unit 105b for each of the first cycle and the second cycle. Accordingly, the detailed setting is automatically performed, and therefore, the supply amount of the cleaning liquid is more suitably adjusted, and in addition, the cleanability of the outer peripheral surface 33a of the conveyance belt 33 and the convenience for the user are further improved.

According to the embodiment, the same effects as those of the above-described embodiment can be obtained.

Contents derived from the embodiments are described below.

A liquid ejection apparatus includes: a conveyance belt configured to convey a medium and having an outer peripheral surface configured to allow the medium to be placed on; an ejection unit configured to eject a liquid to the medium placed on the outer peripheral surface and conveyed; a cleaning unit configured to clean the outer peripheral surface; a cleaning liquid tank configured to store a cleaning liquid in which a part of the cleaning unit is immersed; a supply unit configured to supply the cleaning liquid to the cleaning liquid tank and including an opening and closing unit that switches between an open state in which the cleaning liquid is supplied to the cleaning liquid tank and a closed state in which the cleaning liquid is not supplied to the cleaning liquid tank; and a control unit configured to control the opening and closing unit to adjust a supply amount of the cleaning liquid supplied from the supply unit to the cleaning liquid tank.

According to this configuration, the supply amount of the cleaning liquid can be easily adjusted. Specifically, the control unit controls the opening and closing unit, and therefore, excess or insufficiency of the cleaning liquid is less likely to occur, and the supply amount can be adjusted without the user spending labor. In addition, it is also possible to easily set and reproduce the supply amount desired by the user according to the operation status of the liquid ejection apparatus.

In the above-described liquid ejection apparatus, the control unit adjusts the supply amount of the cleaning liquid supplied from the supply unit to the cleaning liquid tank by controlling a time ratio between the open state and the closed state.

According to this configuration, the supply amount is adjusted by the time control, and therefore, the control of the adjustment of the supply amount is relatively easy as compared with the case where the opening degree of the opening and closing unit is changed.

In the above-described liquid ejection apparatus, the control unit adjusts the supply amount of the cleaning liquid supplied from the supply unit to the cleaning liquid tank by controlling the opening degree of the opening and closing unit in the open state.

According to this configuration, the supply amount is adjusted according to the opening degree of the opening and closing unit, and therefore, it is possible to quickly adjust the supply amount as compared with the case where the time ratio between the open state and the closed state is changed.

The above-described liquid ejection apparatus includes an operation panel, and the control unit controls the time ratio based on information input to the operation panel.

According to this configuration, the user can determine the supply amount.

In the above-described liquid ejection apparatus, one or more setting values indicating the supply amount of the cleaning liquid are displayed on the operation panel, and the control unit controls the time ratio based on a setting value selected from the setting values.

According to this configuration, the setting values are displayed, and therefore, the convenience for the user is improved as compared with the case where the user determines the numerical value of the supply amount.

In the above-described liquid ejection apparatus, the control unit calculates an optimum value of the supply amount of the cleaning liquid based on one or more of a type of the medium, a type of the liquid ejected by the ejection unit, and image data formed on the medium, and displays the one or more setting values on the operation panel based on the calculated optimum value.

According to this configuration, the type of the liquid and the image data affect the easiness of dirt on the outer peripheral surface of the conveyance belt. Therefore, since a suitable setting value corresponding to the degree of dirt is displayed, the cleanability of the outer peripheral surface of the conveyance belt and the convenience for the user are improved.

In the above-described liquid ejection apparatus, one or more values of the time ratio and an average supply amount per unit time can be directly input to the operation panel, and the control unit controls the time ratio based on the value input to the operation panel.

According to this configuration, the convenience for the user is improved because the user can input any value.

In the above-described liquid ejection apparatus, a cycle for controlling the open state and the closed state can be directly input to the operation panel.

According to this configuration, since the time ratio or the like is periodically changed according to the content of the image formed on the medium, the cleanability of the outer peripheral surface of the conveyance belt and the convenience for the user are improved.

In the above-described liquid ejection apparatus, the cycle includes a first cycle and a second cycle, and one or more of the values of the time ratio and the average supply amount per unit time can be directly input to the operation panel for each of the first cycle and the second cycle.

According to this configuration, detailed setting is enabled, and therefore, the cleanability of the outer peripheral surface of the conveyance belt and the convenience for the user are further improved.

In the above-described liquid ejection apparatus, the control unit calculates an optimum value of the supply amount of the cleaning liquid based on one or more of a type of the medium, a type of the liquid ejected by the ejection unit, and image data formed on the medium, and controls the time ratio based on the calculated optimum value.

According to this configuration, the time ratio is controlled according to the print condition, and therefore, the cleanability of the outer peripheral surface and the convenience for the user are improved.

In the above-described liquid ejection apparatus, the control unit determines, based on one or more of the type of the medium, the type of the liquid ejected by the ejection unit, and the image data formed on the medium, a cycle for controlling the open state and the closed state.

According to this configuration, since the time ratio or the like is automatically and periodically changed according to the print condition, the cleanability of the outer peripheral surface of the conveyance belt and the convenience for the user are further improved.

In the above-described liquid ejection apparatus, the cycle includes a first cycle and a second cycle, and the control unit individually controls the time ratio for each of the first cycle and the second cycle.

According to this configuration, the detailed setting is automatically performed, and therefore, the cleanability of the outer peripheral surface of the conveyance belt and the convenience for the user are further improved.

In the above-described liquid ejection apparatus, the control unit determines, based on one or more of a type of the medium, a type of the liquid ejected by the ejection unit, and image data formed on the medium, a cycle for controlling the open state and the closed state, executes first control of setting the opening and closing unit to the open state within a period of the cycle, and then executes second control of setting the opening and closing unit to the closed state, based on the predetermined time ratio.

According to this configuration, the cleanability of the outer peripheral surface of the conveyance belt can be ensured even when the cycle in which the open state and the closed state are changed is longer than the time during which printing is performed by the liquid ejection apparatus. Specifically, in the above-described case, when the second control is executed first and then the first control is executed, the cleaning operation ends while the supply of the cleaning liquid is not completed. Therefore, there is a possibility that the cleaning liquid is insufficient, and sufficient cleanability is not exhibited. In response to this, the supply of the cleaning liquid is performed first, and therefore, sufficient cleanability can be obtained without insufficiency of the cleaning liquid.

The above-described liquid ejection apparatus includes a defining unit configured to define a liquid level of the cleaning liquid stored in the cleaning liquid tank.

According to this configuration, the upper limit of the liquid surface of the cleaning liquid stored in the cleaning liquid tank is defined, and therefore, the cleaning liquid is prevented from being stored in the cleaning liquid tank more than necessary.

The above-described liquid ejection apparatus includes an operation panel, and the control unit controls the opening degree based on information input to the operation panel.

According to this configuration, the user can determine the supply amount.

In the above-described liquid ejection apparatus, one or more setting values indicating the supply amount of the cleaning liquid are displayed on the operation panel, and the control unit controls the opening degree based on a setting value selected from the one or more setting values.

According to this configuration, the setting values are displayed, and therefore, the convenience for the user is improved as compared with the case where the user determines the numerical value of the supply amount.

In the above-described liquid ejection apparatus, the control unit calculates an optimum value of the supply amount of the cleaning liquid based on one or more of a type of the medium, a type of the liquid ejected by the ejection unit, and image data formed on the medium, and causes the operation panel to display an optimum setting value among the one or more setting values based on the calculated optimum value.

According to this configuration, the type of the liquid and the image data affect the easiness of dirt on the outer peripheral surface of the conveyance belt. Therefore, since a suitable setting value corresponding to the degree of dirt is displayed, the cleanability of the outer peripheral surface of the conveyance belt and the convenience for the user are improved.

In the above-described liquid ejection apparatus, a value of the opening degree or a value of an average supply amount per unit time can be directly input to the operation panel, and the control unit controls the opening degree based on the value input to the operation panel.

According to this configuration, the convenience for the user is improved because the user can input any value.

In the above-described liquid ejection apparatus, a cycle for controlling the open state and the closed state can be directly input to the operation panel.

According to this configuration, since the opening degree is periodically changed according to the content of the image formed on the medium, the cleanability of the outer peripheral surface of the conveyance belt and the convenience for the user are improved.

In the above-described liquid ejection apparatus, the cycle includes a first cycle and a second cycle, and one or more of the values of the opening degree and the average supply amount per unit time are configured to be directly input to the operation panel for each of the first cycle and the second cycle.

According to this configuration, detailed setting is enabled, and therefore, the cleanability of the outer peripheral surface of the conveyance belt and the convenience for the user are further improved.

In the above-described liquid ejection apparatus, the control unit calculates an optimum value of the supply amount of the cleaning liquid based on one or more of a type of the medium, a type of the liquid ejected by the ejection unit, and image data formed on the medium, and controls the opening degree based on the calculated optimum value.

According to this configuration, the opening degree is controlled according to the print condition, and therefore, the cleanability of the outer peripheral surface of the conveyance belt and the convenience for the user are improved.

In the above-described liquid ejection apparatus, the control unit determines, based on one or more of the type of the medium, the type of the liquid ejected by the ejection unit, and the image data formed on the medium, a cycle for controlling the opening degree.

According to this configuration, since the opening degree is automatically and periodically changed according to the print condition, the cleanability of the outer peripheral surface of the conveyance belt and the convenience for the user are further improved.

In the above-described liquid ejection apparatus, the cycle includes a first cycle and a second cycle, and the control unit individually controls the opening degree for each of the first cycle and the second cycle.

According to this configuration, the detailed setting is automatically performed, and therefore, the supply amount of the cleaning liquid is more suitably adjusted, and in addition, the cleanability of the outer peripheral surface of the conveyance belt and the convenience for the user are further improved.

What is claimed is:

1. A liquid ejection apparatus comprising:
a conveyance belt configured to convey a medium and having an outer peripheral surface configured to allow the medium to be placed thereon;
an ejection unit configured to eject a liquid to the medium placed on the outer peripheral surface and conveyed;
a cleaning unit configured to clean the outer peripheral surface;
a cleaning liquid tank configured to store a cleaning liquid in which a part of the cleaning unit is immersed;
a supply unit configured to supply the cleaning liquid to the cleaning liquid tank and including an opening and closing unit that switches between an open state in which the cleaning liquid is supplied to the cleaning liquid tank and a closed state in which the cleaning liquid is not supplied to the cleaning liquid tank; and
a control unit configured to control the opening and closing unit to adjust a supply amount of the cleaning liquid supplied from the supply unit to the cleaning liquid tank.

2. The liquid ejection apparatus according to claim 1, wherein
the control unit adjusts the supply amount of the cleaning liquid supplied from the supply unit to the cleaning liquid tank by controlling a time ratio between the open state and the closed state.

3. The liquid ejection apparatus according to claim 1, wherein
the control unit adjusts the supply amount of the cleaning liquid supplied from the supply unit to the cleaning liquid tank by controlling an opening degree of the opening and closing unit in the open state.

4. The liquid ejection apparatus according to claim 2, further comprising:
an operation panel, wherein
the control unit controls the time ratio based on information input to the operation panel.

5. The liquid ejection apparatus according to claim 4, wherein
one or more setting values indicating the supply amount of the cleaning liquid are displayed on the operation panel, and
the control unit controls the time ratio based on a setting value selected from the setting values.

6. The liquid ejection apparatus according to claim 5, wherein
the control unit
calculates an optimum value of the supply amount of the cleaning liquid based on one or more of a type of the medium, a type of the liquid ejected by the ejection unit, and image data formed on the medium, and
displays the one or more setting values on the operation panel based on the calculated optimum value.

7. The liquid ejection apparatus according to claim 2, further comprising:
an operation panel, wherein
one or more of values of the time ratio and an average supply amount per unit time are configured to be directly input to the operation panel, and
the control unit controls the time ratio based on the values input to the operation panel.

8. The liquid ejection apparatus according to claim 7, wherein
a cycle for controlling the open state and the closed state is configured to be directly input to the operation panel.

9. The liquid ejection apparatus according to claim 8, wherein
the cycle includes a first cycle and a second cycle, and
one or more of the values of the time ratio and the average supply amount per unit time are configured to be directly input to the operation panel for each of the first cycle and the second cycle.

10. The liquid ejection apparatus according to claim 2, wherein
the control unit
calculates an optimum value of the supply amount of the cleaning liquid based on one or more of a type of the medium, a type of the liquid ejected by the ejection unit, and image data formed on the medium, and
controls the time ratio based on the calculated optimum value.

11. The liquid ejection apparatus according to claim 10, wherein
the control unit determines, based on one or more of the type of the medium, the type of the liquid ejected by the ejection unit, and the image data formed on the medium, a cycle for controlling the open state and the closed state,
the cycle includes a first cycle and a second cycle, and
the control unit individually controls the time ratio for each of the first cycle and the second cycle.

12. The liquid ejection apparatus according to claim 2, wherein
the control unit
determines, based on one or more of a type of the medium, a type of the liquid ejected by the ejection unit, and image data formed on the medium, a cycle for controlling the open state and the closed state,
executes first control of setting the opening and closing unit to the open state within a period of the cycle, and then executes second control of setting the opening and closing unit to the closed state, based on the predetermined time ratio.

13. The liquid ejection apparatus according to claim 3, further comprising:
an operation panel, wherein
the control unit controls the opening degree based on information input to the operation panel.

14. The liquid ejection apparatus according to claim 13, wherein
one or more setting values indicating the supply amount of the cleaning liquid are displayed on the operation panel, and
the control unit controls the opening degree based on a setting value selected from the one or more setting values.

15. The liquid ejection apparatus according to claim 14, wherein
the control unit
calculates an optimum value of the supply amount of the cleaning liquid based on one or more of a type of the medium, a type of the liquid ejected by the ejection unit, and image data formed on the medium, and
causes the operation panel to display an optimum setting value among the one or more setting values based on the calculated optimum value.

16. The liquid ejection apparatus according to claim 13, wherein
a value of the opening degree or a value of an average supply amount per unit time is configured to be directly input to the operation panel, and
the control unit controls the opening degree based on the value input to the operation panel.

17. The liquid ejection apparatus according to claim 16, wherein
a cycle for controlling the open state and the closed state is configured to be directly input to the operation panel.

18. The liquid ejection apparatus according to claim 17, wherein
the cycle includes a first cycle and a second cycle, and
one or more of the values of the opening degree and the average supply amount per unit time are configured to be directly input to the operation panel for each of the first cycle and the second cycle.

19. The liquid ejection apparatus according to claim 3, wherein
the control unit
calculates an optimum value of the supply amount of the cleaning liquid based on one or more of a type of the medium, a type of the liquid ejected by the ejection unit, and image data formed on the medium, and
controls the opening degree based on the calculated optimum value.

20. The liquid ejection apparatus according to claim 19, wherein
the control unit determines, based on one or more of the type of the medium, the type of the liquid ejected by the ejection unit, and the image data formed on the medium, a cycle for controlling the opening degree,
the cycle includes a first cycle and a second cycle, and
the control unit individually controls the opening degree for each of the first cycle and the second cycle.
